(19) United States
(12) Patent Application Publication
(10) Pub. No.: US 2025/0205877 A1
(43) Pub. Date: Jun. 26, 2025

(54) Articulated Robot Arm Having a Thermally Conductive Member for Cooling

(71) Applicant: ABB Schweiz AG, Baden (CH)

(72) Inventors: Stacy Rothenhöfer, München (DE); Felix Schreiber, Stockdorf (DE)

(73) Assignee: ABB Schweiz AG, Baden (CH)

(21) Appl. No.: 19/078,482

(22) Filed: Mar. 13, 2025

Related U.S. Application Data
(63) Continuation of application No. PCT/EP2022/025429, filed on Sep. 13, 2022.

(51) Int. Cl. B25J 9/10; B25J 9/00; B25J 19/00

(52) U.S. Cl. CPC B25J 9/106; B25J 9/0009; B25J 9/102; B25J 19/0054

(57) ABSTRACT

An articulated robot arm comprises at least a first link and a second link rotatably connected to the first link by a joint unit, the joint unit comprising a shaft that is received in a housing of the first link, is rotatable around an axis relative to the first link, and is non-rotatably connected to the second link, and a drivetrain unit mounted inside the housing of the first link for rotating the shaft with an annular gap being formed between an outer side of the drivetrain unit and an inner side of the housing. At least one thermally conductive member is mounted in the annular gap and is disposed in thermal contact with the outer side of the drivetrain unit and the inner side of the housing.

### CROSS-REFERENCE TO RELATED APPLICATIONS

The instant application claims priority to International Patent Application No. PCT/EP2022/025429, filed Sep. 13, 2022, which is incorporated herein in its entirety by reference.

### FIELD OF THE DISCLOSURE

The present disclosure generally relates to an articulated robot arm.

### BACKGROUND OF THE INVENTION

Conventionally, an articulated robot arm comprises a plurality of links that are connected to one another by rotary joints, each rotary joint comprising a drivetrain unit which is non-rotatably mounted on a first one of the plurality of links and is adapted to rotate a shaft around an axis relative to the first link, the shaft being non-rotatably connected to a second one of the plurality of links. In operation, the drivetrain unit produces heat. When the drivetrain unit is mounted within a housing of the first link, the housing adds to the thermal resistance that opposes heat dissipation from the drivetrain unit, so that appropriate measures must be taken in order to prevent overheating of the drivetrain unit. Equipment for cooling a robot motor housing by injection of compressed air is proposed e.g. by Exair.com, as shown, for example, at https://www.exair.com/knowledgebase/applicationsearch/cooling-robot-motor-housings.html

To cool a drivetrain unit at a distal end of a robot arm, a compressed air duct must be provided that extends along the robot arm up to the drivetrain unit. Such a pipe adds not only to the complexity of the robot arm, but also to bulkiness, and to power consumption of the drivetrain units.

### BRIEF SUMMARY OF THE INVENTION

The present disclosure generally describes one or more embodiments for a robot arm in which the risk of overheating is reduced by simple and efficient structures. To that effect, the disclosure describes an articulated robot arm comprising at least a first link and a second link rotatably connected to the first link by a rotary joint, the joint comprising a shaft which is rotatable around an axis relative to the first link and is non-rotatably connected to the second link, and a drivetrain unit mounted inside a housing of the first link for rotating the shaft with an annular gap being formed between an outer side of the drivetrain unit and an inner side of the housing, in which at least one thermally conductive member is mounted in said gap in thermal contact with the outer side of the drivetrain unit and the inner side of the housing.

Typically, in an articulated robot having a drivetrain unit inside the housing of a first link, the drivetrain unit is supported by an end face member of the housing that faces the second link. Heat dissipation via such an end face member is inefficient. One reason is that the drivetrain unit tends to comprise a reduction gear between the end face member and a motor, so that the reduction gear will contribute to thermal resistance between the motor, usually being the most important source of heat in the drivetrain unit, and the end face member. Another is that the end face member, facing the second link at a small distance, cannot dissipate heat into the surrounding air, but only conduct it to other regions of the housing that can. In the robot arm of the invention the thermally conductive member can convey the heat directly to such regions of the housing, thereby enabling the motor to operate continuously at high power.

### BRIEF DESCRIPTION OF THE SEVERAL VIEWS OF THE DRAWING(S)

FIG. 1 is an outline view of an articulated robot arm in accordance with the disclosure.

FIG. 2 is a section view in an axial direction of a link of the robot arm of FIG. 1.

FIG. 3 is a section view in a radial direction of the link of FIG. 2.

FIGS. 4 and 5 are radial sections of the link illustrating different types of thermally conductive members.

FIG. 6 is a perspective view of a thermally conductive member in accordance with the disclosure.

### DETAILED DESCRIPTION OF THE INVENTION

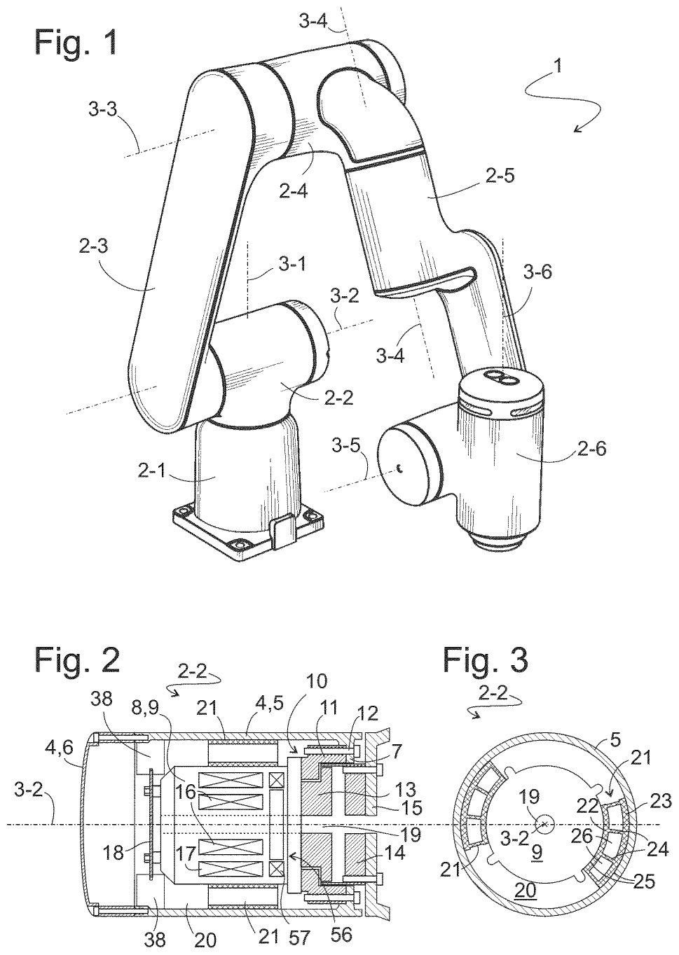

FIG. 1 is a perspective view of a robot arm 1 to which the present invention can be applied. The robot arm 1 has a stationary link or base 2-1 of substantially cylindrical shape, which accommodates a motor for rotating the other links 2-2 to 2-6 around a vertical axis 3-1. Link 2-2 is also substantially cylindrical and houses a motor for rotating all more distal links 2-3 to 2-6 around an axis 3-2. Link 2-4 has a substantially cylindrical portion in which a motor is coupled to more proximal link 2-3, for rotating links 2-4 to 2-6 around axis 3-3. A motor in link 2-5 drives rotation around an axis 3-4. Link 2-6 has two intersecting cylindrical portions, one of which houses a motor for rotating link 2-6 around axis 3-5 and the other, for rotating an end effector, not shown, around an axis 3-6.

FIG. 2 is a schematic cross section of link 2-2 along axis 3-2. Cross sections of other links may vary in details, but the components described below can be identical in all.

A housing 4 of link 2-2 comprises a substantially cylindrical portion 5 and a lid 6 screwed onto an open end of cylindrical portion 5. At the other end of the cylindrical portion, a flange 7 extends radially inwardly along the entire circumference of the cylindrical portion. The flange 7 supports a drivetrain unit 8 comprising an electric motor 9 and a reduction gear 10, namely a harmonic drive gear.

The motor 9 is supported by means of the reduction gear 10 in that a hollow circular spline 11 is fixed to the flange 7 by screws 12, and a stator portion of the motor 9 is, in turn, screwed to the circular spline 11. A rotor portion of the motor 9 is connected to a wave generator 13 of the reduction gear 10. A flex-spline 14 of the harmonic drive gear is attached to an end face 15 of the adjacent link 2-3, thus forming a shaft by which the motor 9 can rotate link 2-3 relative to link 2-2.

A circuit board 18 can be attached to the motor 9 on a side facing away from the reduction gear, carrying motor driver circuitry. The motor 9, the circuitry and the reduction gear 10 form a drivetrain unit for driving a rotation of link 2-3 relative to link 2-2.

A passage 19 extends along axis 3-2 through the reduction gear 10, the motor 9 and, possibly, the circuit board 18, serving as a cable duct conveying power and control signals for motors of more distal links.

When the robot is operating, Joule heat is generated in rotor and stator coils 16, 17 of the motor 9, and, possibly, in the motor driver circuitry. Friction between the wave generator 13 and the flex-spline 14 can be another source of heat. This heat must be dissipated to the environment efficiently enough to prevent overheating of the motor and the circuitry. Dissipation by air directly to the cylindrical portion 5 and the lid 6 is not efficient. Heat from the motor 9 can dissipate towards the environment through the reduction gear 10, its massive metallic circular spline 11 being in intimate contact with both the stator portion of the motor 9 and the flange 7. However, friction heat generated in the flex-spline 14 can decrease the temperature gradient between the motor 9 and the reduction gear, so that when wear causes increased friction in the reduction gear 10, overheating of the motor 9 or of the driver circuitry may result. This is why additional thermally conductive members are provided in an annular gap 20 between an outer side of the drivetrain unit 8 and an inner side of the cylindrical portion 5. FIG. 2 illustrates such thermally conductive members 21 between the motor 9 and the cylindrical portion 5, preferably in a position axially overlapping the coils 16, 17 of the motor 9.

The drivetrain unit 8 may further comprise a brake 56, which can also be cooled by the thermally conductive members 21. The brake can be of any conventional design, preferably operating by friction, and having a brake disk and brake pads continuously urged towards each other by a spring, and an electromagnetic actuator 57 that is continuously powered so as to overcome the force of the spring and hold the disk and brake pads apart. The brake thus ensures that in case of a power failure, the robot will stand still but will not collapse. In this brake 56, the main source of heat to be dissipated via the thermally conductive members 21 is the actuator 57. In FIG. 2, the actuator 57 is shown in axial overlap with the thermally conductive members 21.

According to a first embodiment shown in radial cross section in FIG. 3, the thermally conductive members 21 are pieces of an extrusion profile, preferably of aluminum, having a concave cylindrical inner flange 22 with a curvature closely fitting the outer side of the motor 9, a convex cylindrical outer flange 23 with a curvature fitting the inner side of the cylindrical portion 5, and at least one, preferably several, radially extending walls 24 extending from the inner flange 22 to the outer flange 23.

Preferably a layer 25 of heat conducting paste is provided between the flanges 22, 23 and the surfaces of the motor 9 and the cylindrical portion 5, in order to ensure an efficient heat flow across the entire surface of the flanges 22, 23. Conveniently, the layer 25 can be a graphite layer or a graphite-containing layer, since the lubricating properties of graphite facilitate the introduction of the thermally conductive members 21 into the gap 20 in friction contact with the surfaces of the motor 9 and the cylindrical portion 5.

As shown in FIG. 3, the arrangement of the thermally conductive members 21 is symmetric with respect to axis 3-2, in order to prevent an asymmetric load on the reduction gear 10 that might cause the transmission ratio of the reduction gear 10 to fluctuate and thus affect the precision of operation of the robot arm 1.

In the embodiment of FIG. 3, four radially extending walls 24 and the flanges 22, 23 of each thermally conductive member 21 forms a framework defining three longitudinal cavities 26. By filling these cavities 26 with thermally conductive material, the cooling capacity of the thermally conductive members 21 can be increased substantially. The thermally conductive material can e.g. be graphite or the graphite-containing material that is used for the layers 25.

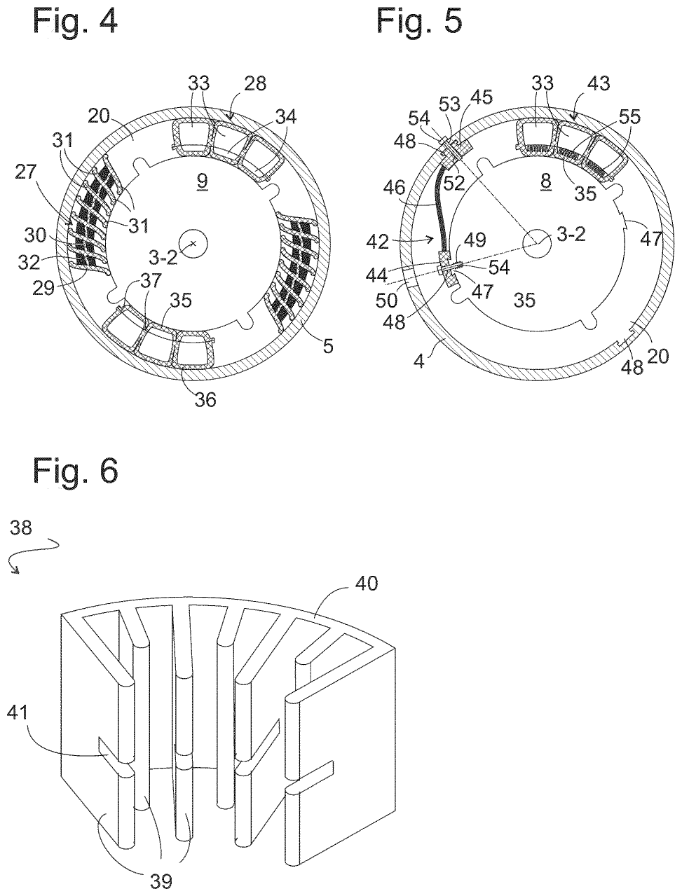

FIG. 4 illustrates two other embodiments of thermally conductive members 27, 28 that can be inserted in the gap 20 between the motor 9 and the cylindrical portion 5.

The thermally conductive member 27 comprises a framework formed of an extrusion profile 29 of metal, preferably aluminum, having a central web 30 which, when installed as shown, extends circumferentially with respect to axis 3-2, and ribs 31 that extend from the central web 30 towards the motor 9 and the cylindrical portion 5 and are inclined with respect to the radial direction. The radial dimension of the extrusion profile 29 at extrusion time may be slightly larger than that of gap 20, so that in order to insert the thermally conductive member 27 into the gap, inclination of the ribs 31 must be increased, giving the central web the slightly undulated shape shown in the Fig,, and causing the edges of the ribs 31 to press against the motor 9 and the cylindrical portion 5 and thus to ensure intimate thermal contact.

Grooves between adjacent ribs 31 can be filled with malleable thermally conductive material 32, just like the cavities 26 of members 21.

The thermally conductive member 28 comprises one or more sealed cavities 33 filled with liquid and vapor phases of a heat carrier fluid. On an inner side of each cavity 33, facing the motor 9, a wick layer 34 is disposed which tends to absorb the liquid phase of the heat carrier fluid, causing it to be evaporated by heat from the motor 9. An outer side of each cavity 33 is cooled by contact with the cylindrical portion 5, causing the vapor to condense there. When droplets of liquid formed at the outer side become big enough to be moved by the motion of the robot arm 1, they are absorbed as soon as they reach the wick layer 34. Thus, the wick layer 34 is always moist, and efficient transfer of heat to the cylindrical portion 5 is ensured.

The thermally conductive member 28 can be formed by providing two flexible films of a resin material, forming the wick layer 34 by depositing a non-woven layer of thermoplastic fibers on an inner one 35 of the films, placing the outer film 36 on the wick layer 34, and locally welding the thus obtained sandwich structure so as to form weld seams 37 which delimit the cavities 33 and in which the fibers of the wick layer 34 are fused into a sealing layer between the two films 35, 36. The resin material of the films 35, 36 can be any material capable of forming a scaling junction with the material of the wick layer 34.

Unlike members 21, 27, the thermally conductive member 28 does not have to be pressed into the gap 20 in order to ensure intimate thermal contact. When cold, it can be thinner than the gap 20 and can simply be slid into it. When the motor 9 heats up in operation, so will the thermally conductive member 28. Formation of vapour inside causes the member 28 to expand, so that the films 35, 36 come into intimate contact with the motor 9 and the cylindrical portion 5, ensuring efficient cooling when it is needed.

Two more embodiments of thermally conductive members 42, 43 are shown in FIG. 5. Member 42 comprises inner and outer flanges 44, 45, which may be portions of an extruded profile made of highly thermally conductive metal such as aluminum or copper, and a flexible member 46 of braided wire between the flanges 44, 45. Axially extending rails 47 capable of engaging a profile of inner flange 45, e.g. having a dovetail cross section, are formed on the outer side of drivetrain unit 8. Similar mating profiles 48 are formed on the outer flange 45 and the inner side of housing 4. This allows a thermally conductive member 42 to be installed in gap 20 by engaging the respective profiles of the flanges 44, 45, the drivetrain unit 8 and the housing 4 at an end of housing where lid 6 has been removed, displacing member 42 along axis 3-2 until a plain bore 49 in inner flange 44 overlaps with a threaded bore 50 in drivetrain unit 8 and a window 51 in housing 4, and a threaded bore 52 of outer flange 43 overlaps with a plain bore 53 of housing 4, and then tightly attaching the flanges by screws 54.

Thermally conductive member 43 is a variant of member 28 of FIG. 4. Wick layer 34 is replaced here by a wick structure 55 fine enough to hold the liquid phase of the heat carrier fluid by capillary effect. The wick structure 55 can e.g. be a plurality of closely spaced ribs or filiform elements integrally formed and projecting into the cavities 33 from inner film 35 of member 43.

FIG. 6 illustrates a thermally conductive member 38 for cooling the circuit board 18. Here, ensuring a press contact with heat-releasing components on the circuit board 18 is difficult; therefore the thermally conductive member 38 is designed to absorb heat from the air close to the circuit board by means of fins 39 extending radially inwards from a base plate 40. The base plate 40 has a curvature matching the inner side of cylindrical portion 5. Some of the fins 39 have a cutout 41 for engaging the edge of the circuit board 18, ensuring that when the circuit board 18 is inserted into the cylindrical portion 5 with one or more thermally conductive members 38 engaging its edges, the thermally conductive members 38 are firmly held both axially and radially. The fins 39 may have a sandwich structure, with metal sheets on both sides, and a graphite layer in between.

For heat to be received and forwarded efficiently by the thermally conductive member, the thermal contact should best be a press fit contact, i.e. a contact in which the thermally conductive member presses against the drivetrain unit and the housing. Alternatively, one or more screws may be used to hold the thermally conductive member pressed against the drivetrain unit or the housing, or the contact may be ensured by a layer of adhesive.

Where the drivetrain unit comprises an electric motor, the thermally conductive member should be located adjacent to coils of the motor in order to dissipate heat from the motor efficiently.

Where the drivetrain unit further comprises driver circuitry for supplying power to the motor, and which may become hot in operation, the thermally conductive member (or a further thermally conductive member) may be located adjacent to said circuitry.

Where the drivetrain unit comprises a reduction gear, the thermally conductive member (or a further thermally conductive member) may extend around a housing of the reduction gear, so as to fill a gap between the gear housing and the link housing surrounding it. When the reduction gear is a harmonic drive gear, the housing of the harmonic drive gear preferably comprises a circular spline.

Heat can also be generated by a brake, be it by friction, eddy currents or whatever other physical effect the brake may be using to decelerate a relative movement of the first and second links, or by the operation of an actuator displacing or holding in position moveable components of the brake. Therefore, the thermally conductive member (or a further thermally conductive member) may be provided adjacent to the brake.

For an efficient thermal contact, the thermally conductive member may have an outer flange in contact with the housing and/or an inner flange in contact with the drivetrain unit.

Further, at least one wall extending radially inwards from said outer flange and/or inwards from said outer flange may contribute to heat flow.

Preferably, the at least one wall extends in an axial direction parallel to the shaft.

Alternatively, a braided wire member or some other member formed of a plurality of flexible elements, such as a multi-foil member, or multi-stranded member may contribute to the heat flow.

Where the thermally conductive member is not compressed between the outer side of the drivetrain unit and the inner side of the housing, it may be held in position by locking engagement with an axially extending rail of the housing or of the drivetrain unit. Further, intimate thermal contact between mating surfaces of the rail and the flange can be ensured by screwing.

The thermally conductive member can be manufactured as an extrusion profile, in particular when it has longitudinally extending flanges and walls as described above, its extrusion direction should be parallel to the axis.

The thermally conductive member can be circular in cross section, forming a collar around the entire drivetrain unit. Preferably, it is a circular arc in cross section, since the arc shape is smaller and more convenient to manufacture, and will allow an intimate contact of the thermally conductive member, on the one hand, and the drivetrain unit or the housing, on the other, regardless of possible tolerances in the radius of curvature of the drivetrain unit, the housing and the thermally conductive member.

The thermally conductive member will usually not extend along the whole length of the drivetrain unit. Where the drivetrain unit comprises a plurality of subunits having different diameters, such as a motor, a reduction gear and/or a circuitry unit, any of these units may have a thermally conductive member of matching shape associated to it.

The thermally conductive member may be a stiff element of one single material (preferably with good thermal conductivity, such as aluminum, copper).

A monolithic block of metal will have excellent heat conducting properties if in intimate contact with both the drivetrain unit and the housing, but will be both heavy and expensive. Further, obtaining such intimate contact is usually difficult due to manufacturing tolerances. In order to save weight and/or to achieve an intimate thermal contact in spite of possible dimensional tolerances of the gap that accommodates the thermally conductive element, the thermally conductive member may comprise a framework of metal and a malleable thermal conductor such as graphite filling at least one cavity or recess of the framework. In the framework, structural elements may be thin enough to yield to pressure when inserted into the gap, whereas the malleable material is held in place by the framework and can have a cross section wide enough to provide for sufficient heat flow and improved thermal conductivity.

Preferably, the framework comprises one or more cavities that can be filled with the malleable thermal conductor. When the framework is formed by extrusion, the cavities will be elongate, and may have open ends in the direction of extrusion.

Preferably, the malleable thermal conductor comprises graphite. Graphite has excellent thermal conductivity and, due to its softness, will easily adapt to the shape of the framework or of surfaces of the drivetrain unit and the housing, thus forming an intimate thermal contact.

The thermally conductive member may also comprise a heat pipe. In order to facilitate a radially outward flow of heat through the heat pipe, a wall at a radially inner side of the heat pipe should be provided with a wick material, such as a sponge or a fleece, or a wick structure, such as ribs spaced closely enough to each other to trap liquid heat carrier fluid in interstices between them by capillary effect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

1 robot arm
2 link
3 axis
4 housing
5 cylindrical portion
6 lid
7 flange
8 drivetrain unit
9 electric motor
10 reduction gear
11 circular spline
12 screw
13 wave generator
14 flex-spline
15 end face
16 rotor coil
17 stator coil
18 circuit board
19 passage
20 gap
21 thermally conductive member
22 inner flange
23 outer flange
24 wall
25 thermally conductive layer
26 cavity
27 thermally conductive member
28 thermally conductive member
29 extrusion profile
30 central web
31 rib
32 thermally conductive material
33 cavity
34 wick layer
35 inner film
36 outer film
37 weld seam
38 thermally conductive member
39 fin
40 base plate
41 cutout
42 thermally conductive member
43 thermally conductive member
44 inner flange
45 outer flange
46 flexible member
47 rail
48 profile
49 plain bore
50 threaded bore
51 window
52 threaded bore
53 plain bore
54 screw
55 wick structure
56 brake
57 actuator

What is claimed is:

1. An articulated robot arm, comprising:
at least a first link and a second link, the second link connected to the first link by a rotary joint;
wherein the rotary joint comprises a shaft that is rotatable around an axis relative to the first link and is non-rotatably connected to the second link;
a drivetrain unit mounted inside a housing of the first link for rotating the shaft with an annular gap being formed between an outer side of the drivetrain unit and an inner side of the housing;
wherein at least one thermally conductive member is disposed within the annular gap in thermal contact with the outer side of the drivetrain unit and the inner side of the housing.

2. The articulated robot arm of claim 1, wherein the first link has an end face member facing the second link and supporting the drivetrain unit.

3. The articulated robot arm of claim 1, wherein the thermal contact is at least one of a press fit contact, a threaded fastener contact, and an adhesive contact.

4. The articulated robot arm of claim 1, wherein the drivetrain unit comprises an electric motor and the thermally conductive member is located adjacent to coils of the motor.

5. The articulated robot arm of claim 4, wherein the drivetrain unit further comprises driver circuitry associated with the electric motor, and wherein the thermally conductive member is located adjacent to the driver circuitry.

6. The articulated robot arm of claim 1, wherein the drivetrain unit comprises a reduction gear and the thermally conductive member extends around a housing of the reduction gear, wherein the reduction gear is a harmonic drive gear and the housing comprises a circular spline of the harmonic drive gear.

7. The articulated robot arm of claim 1, wherein the drivetrain unit comprises a brake, and wherein the thermally conductive member is located adjacent to the brake.

8. The articulated robot arm of claim 1, wherein the thermally conductive member includes least one of an outer flange in contact with the housing and an inner flange in contact with the drivetrain unit.

9. The articulated robot arm of claim 1, wherein the thermally conductive member comprises at least one radially extending wall extending in a direction parallel to the axis.

10. The articulated robot arm of claim 1, wherein the thermally conductive member comprises at least one of a braided wire member, a multi-foil member, and a multi-stranded member.

11. The articulated robot arm of claim 8, wherein the at least one flange is in locking engagement with an axially extending rail of the housing or of the drivetrain unit.

12. The articulated robot arm of claim 1, wherein the thermally conductive member comprises a piece of extrusion profile formed along an extrusion direction, the extrusion direction being parallel to the axis.

13. The articulated robot arm of claim 1, wherein the thermally conductive member is shaped as a circle or at least a circular arc in cross section, the circular arc extending over an angle of less than 180°.

14. The articulated robot arm of claim 1, wherein the thermally conductive member comprises a framework of metal and a malleable thermal conductor filling at least one cavity or recess of the framework.

15. The articulated robot arm of claim 14, wherein the malleable thermal conductor comprises graphite.

16. The articulated robot arm of claim 1, wherein the thermally conductive member comprises a heat pipe.

17. The articulated robot arm of claim 16, wherein a wall at a radially inner side of the heat pipe is provided with a wick material or structure.

18. The articulated robot arm of claim 16, wherein a wall of the heat pipe is made from a flexible resin film.
